(19) United States
(12) Patent Application Publication
(10) Pub. No.: US 2002/0088331 A1
(43) Pub. Date: Jul. 11, 2002

(54) Violin family musical instrument bridge with independent string height adjustment

(76) Inventor: Mike Pecanic, Upland, CA (US)

Correspondence Address: Dr. Mike Pecanic, 1016 W. Pine Apt. A, Upland, CA, 91786, US

(21) Appl. No.: 09/755,260

(22) Filed: Jan. 8, 2001

(51) Int. Cl. G10D 3/04

(52) U.S. Cl. 84/307

(57) ABSTRACT

An improved musical instrument bridge for the violin family having independently adjustable bridge saddles. Each bridge saddle has at least one height adjustment rod/screw assembly allowing each saddle independent raising and lowering in relation to the other bridge saddles. Each bridge saddle has three points of contact in the vertical plane to the bridge body improving stability in the vertical and horizontal planes of the bridge. The invention allows each string of the musical instruments in this family to be adjusted to the appropriate height required by either or both instrument player considerations and climatic conditions. The scope of the invention also allows for the use of materials other than the traditional woods by including the utilization of composite materials and lightweight metals and plastic compounds in multiple combinations thereof.

### BACKGROUND

1. Field of Invention

This invention relates to musical instruments, specifically to the bridges of acoustic stringed instruments in the violin family

2. Description of Prior Art

Musical instrument design has an extensive history that parallels general wood working principles. Traditional construction of the violin family instrument bridges consist of a single section of wood, cut and carved in consort with the neck pattern and relief (quarter-sawn billet cut by shearing the wood to insure harmonious grain alignment, as would be commonly understood by someone who is versed in the art of general woodworking and musical instrument construction) and having laterally sawn grooves to accept each string on the top of the bridge. The purpose of the bridge is twofold. It is where the vibrational energy is transferred to the body while maintaining the strings at a constant height off the fingerboard. In prior art the only method of adjusting the string height was to remove wood from the bottom of the bridge (“feet”) FIG. 3 or removing wood from the top of the unit and then resawing the lateral grooves to accept the strings.

Traditional bridges are not adjustable by the instrument player. There is a constant need for the bridges to be adjusted as climatic conditions cause acoustic stringed instruments to contract and expand, the wooden necks of these stringed instruments are under constant pressure which causes a relief bowing of the wood surface of the fingerboard, and performance styles, arco (played with a bow) and pizzicato (plucked with the fingers) require different string heights in relation to the fingerboard. Traditional bridges require players to compromise between the style requirements because traditional bridges are non-adjustable.

Further, since most acoustic stringed instrument players are not versed in the art of woodworking or stringed instrument making or repair, adjustment of the bridge is impossible at the moment it is needed.

Modern attempts to make the acoustic stringed instrument bridge adjustable have included (for example) removing transverse sections of each of the legs of the traditional bridge and inserting a device that consisted of a threaded shaft with a wheel positioned approximately at the middle of the shaft FIG. 2. This method is ineffective as it causes two ancillary problems. The first problem is that this causes strings that do not need to be adjusted to move from their relative positional height. The second problem caused is that the cantilevering of the predetermined curvature of the uppermost top of the bridge, i.e. the bridge no longer conforms to the signature profile of the fingerboard.

### OBJECTS AND ADVANTAGES

Accordingly, several objects and advantages of the present invention are:

(a) increased ease of string height adjustment for acoustic stringed instrument players and repair persons.

(b) the elimination of distortion in fingerboard signature profile that necessarily needs to be reflected by the bridge profile.

(c) a bridge that is instantly adjustable as climatic conditions, either expansion or contraction, cause string heights to change.

(d) a bridge that is instantly adjustable as playing styles demand, either Arco (bowed) or Pizzicato (plucked with fingers).

(e) each string can be raised or lowered individually and independently of the other strings.

### DRAWING FIGURES

FIG. 1 shows a front exploded view of the preffered embodiments of the present invention.

FIG. 2 shows a front exploded view of a modern adjustable acoustic string instrument bridge with the threaded shaft, wheeled adjusters installed in the legs of the bridge body.

FIG. 3 shows a front elevational view of the traditional violin family musical instrument bridge with no adjusters.

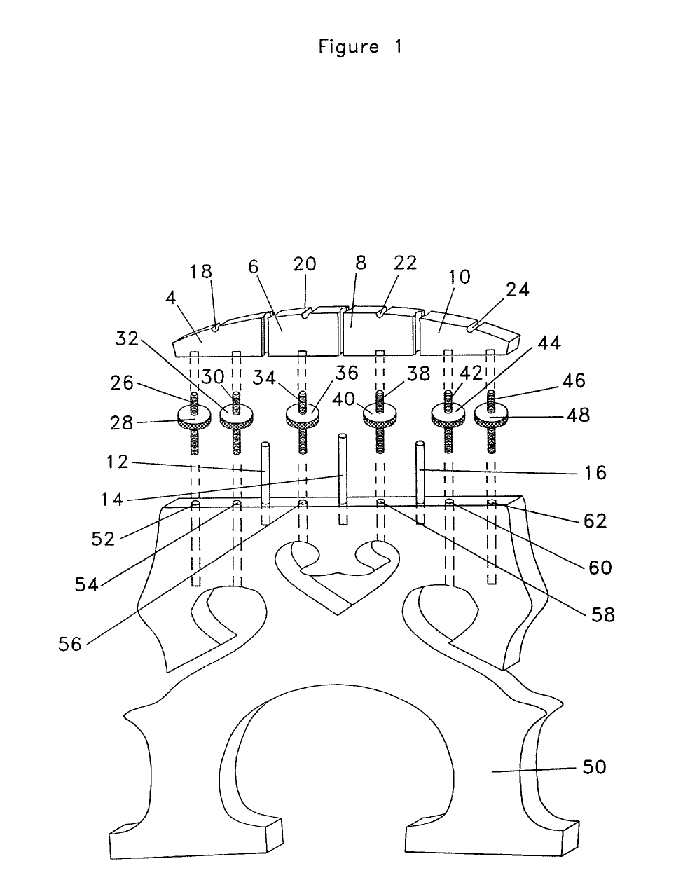

### DESCRIPTION-FIGS. 1 TO 3

### Figure 1

FIG. 1 shows an exploded perspective of the preferred embodiment of the invention. The top pieces of the hardwood (or other material) independent bridge saddles designated 4, 6, 8, 10 (henceforth known as the bridge saddles) are drilled and tapped to accept threaded rods 26, 30, 34, 38, 42, 46. The matching non-threaded holes (cavities) in the bridge body 50 are drilled accordingly 52, 54, 56, 58, 60, 62 and extend vertically as non-thru holes in the independant bridge saddles, 4, 6, 8, 10.

Likewise, the bridge saddles 4, 6, 8, 10 are axially slotted to accept to the smooth rods 12, 14, 16 which are installed in the bridge body 50 in the positions appropriate to the edges of bridge saddles 4, 6, 8, 10.

Further, bridge saddle 4 is positioned upon threaded rods 26 and 30 with the adjustment wheels 28 and 32 installed on the appropriate threaded rod so that this assembled unit is then inserted into the corresponding non-threaded holes in the bridge body 50. This process is repeated for the rest of the bridge saddle assemblies 6(34, 36), 8(38, 40) and 10(42, 44, 46, 48).

FIG. 1 is a front perspective view of the assembly process of the invention with the smooth rods 12, 14, 16 installed in the bridge body 50. The threaded rods 26, 30, 34, 38, 42, 46 are threaded and glued or in other manner attached into the bridge saddles 4, 6, 8, 10 and are stationary and secured into position. When assembled, the adjustment wheels 28, 32, 36, 40, 44, 48 rest upon the top surface of the bridge body 50 and effect the vertical raising and/or lowering of each bridge saddle accordingly when the wheel is rotated either clockwise or counterclockwise.

In the preferred embodiment each bridge saddle is made stronger by having three points of contact to maintain vertical and longitudinal stability hence enhancing the vibrational sonic coupling and to protect the alignment from normal wear and abuse. Bridge saddle 4 has two threaded rods that are equally spaced apart from the center point of string contact 18 to equalize the resultant downward pressure of a string tuned up to pitch. This manner of assembly is repeated for bridge saddle assembly 10 and string contact point 24. Additionally, both bridge saddle 4 and 10 have contact with stationary, smooth rods, 12, 16, increasing stability and sonic coupling.

The interior bridge saddles 6 and 8 also have three points of contact each. As in the case of bridge saddle 6, the threaded rod 34 and adjustment wheel 36 are positioned directly underneath the string contact point 20 while two other points of contact are the stationary smooth rods 12 and 14. In this instance the stationary rods perform the function of not only providing better sonic coupling but also prevent twisting of the bridge saddle away from the appropriate right angle created by the string passing over the properly installed bridge. The above design rationale applies to the matching bridge saddle assembly 8(22, 38, 40). In this manner, the horizontal plane stability is insured by each bridge saddle having three points of continuous contact. In the vertical plane stability is also enhanced by three points of contact.

While I believe that this is the explanation for increased stability and responsiveness of the individual bridges saddle pieces I do not wish to be bound by this belief.

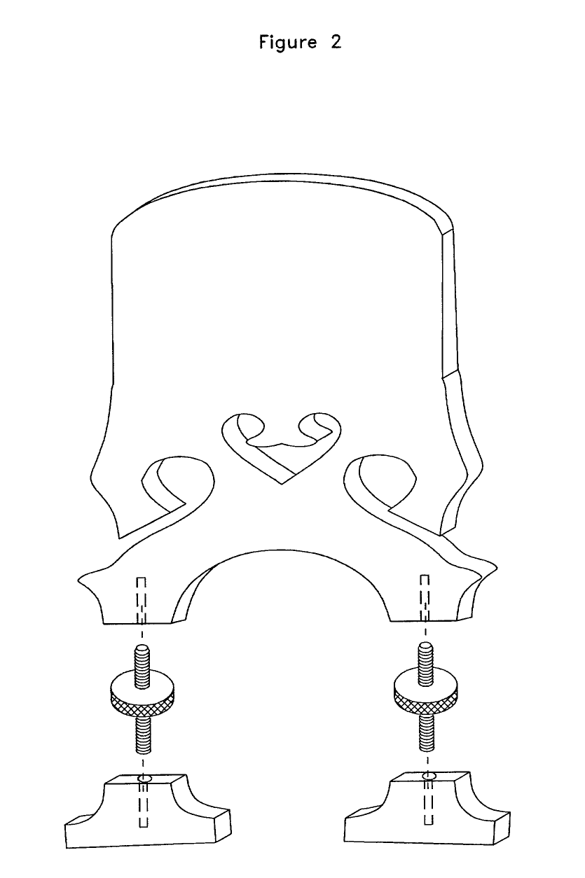

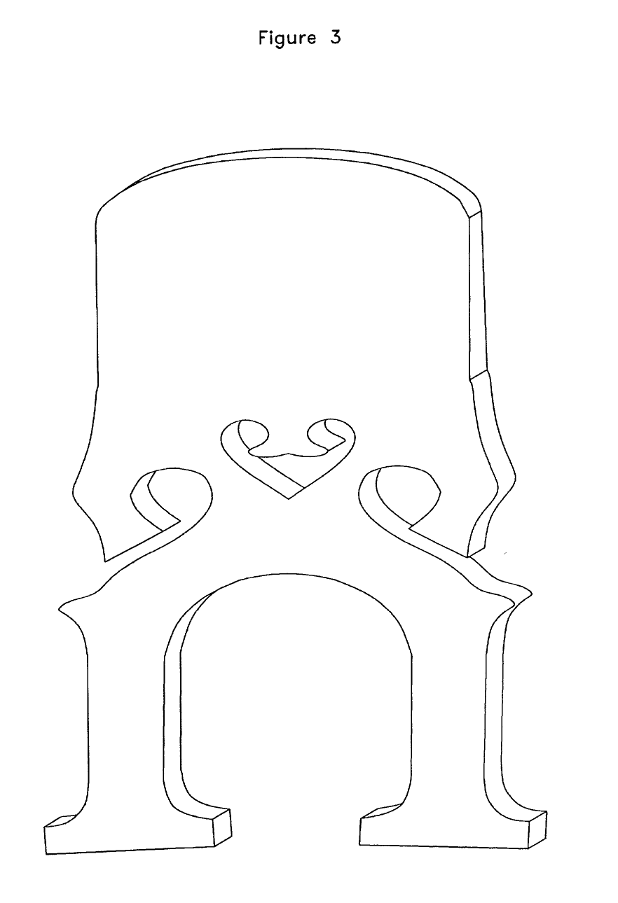

As briefly described earlier, the inventor believes that it is the superior height adjustment capabilities that is made possible by the invention that gives each part and the sum of the parts superior adjustability over prior art FIG. 2 and FIG. 3.

Since, as shown in FIG. 1, (the preferred embodiment of the invention) each of the strings contact the bridge saddle top, each of which has its own three points of contact, the invention will have superior height adjustability while maintaining vibrational transference over prior art.

### Figure 2

FIG. 2 is an exploded view of a traditional violin family bridge with threaded shaft adjusters installed in the “legs” of the bridge.

### Figure 3

FIG. 3 is a front elevation view of a traditional violin family bridge with no adjustment capabilities.

### OPERATION-FIG. 1

The manner of using the individually adjustable string height musical instrument bridge is similar to that of electric musical instrument bridges in present use. The necessary range of height of the strings from the body and fingerboard are determined. The bridge saddles 4, 6, 8, 10 are set at middle position on the threaded rod 26, 30, 34, 38, 42, 46, by rotating the threaded wheels 28, 32, 36, 40, 44, 48 and then height-adjusted in the same manner to conform to the fingerboard profile. If necessary, material is removed from the feet of the bridge. The bridge is then positioned in the appropriate place on the instrument body and the strings are tightened to their appropriate pitch.

### SUMMARY, RAMIFICATION, AND SCOPE

Accordingly, the reader will see that the individually adjustable string height feature of this invention can be used to set the string heights as well as the fingerboard profile easily and conveniently. In present-use bridges, the necessary height of the strings from the top of the body of the instrument and from the fingerboard is determined then the bridges are cut in two different areas. Present day bridge tops are first profiled to emulate the fingerboard signature profile and then the bottom of the bridge (“feet”) are cut to fit the angle of the body and then further sanded to conform to the belly profile. This procedure needs to be repeated for each of the climatic conditions and playing characteristics

Utilizing the preferred embodiments of the present invention, the top of the bridge does not need to be cut to profile. In addition, the stringed instrument player can compensate for climatic conditions as well as playing styles demand simultaneously. Furthermore, the stringed instrument player can adjust the instrument without having to seek out a repairman versed in the general art of stringed instrument repair.

Although the description above contains many specificities, these should not be construed as limiting the scope of the invention but as merely providing illustrations of some of the presently preferred embodiments of the present invention. For example the bridge body can be of wood and the bridge saddles can be of composite, metal, plastic, etc.; the threaded rods and threaded wheels can be constructed from metals and/or a combination of composite materials.

These variations in material and design specifications may be seen to deviate extensively from exemplifications delineated herein without departing from the spirit of the present invention.

I claim:

1. A bridge for stringed violin family musical instruments wherein:
said bridge incorporates individual bridge saddles, extending generally perpendicular to the strings of said musical instrument, said bridge also employing smooth rods in parallel vertical position relative to said individual saddles wherein said smooth rods facilitate vertical movement of said saddles, also insuring horizontal stability of said saddle; said bridge further incorporating a flat, threaded wheel(s) installed on said threaded rod(s) being mounted generally beneath each saddle upon which acts as vertical height adjustment wheels for the purpose of changing the height of each saddle piece with regard to a base section of said bridge.

2. A bridge for stringed violin family musical instruments according to claim 1 wherein:
said individual bridge pieces may employ said smooth rods, threaded rods, and adjustment wheels in either single or multiple arrangements.

3. A bridge for stringed vilolin family musical instruments according to claim 1 wherein:
said smooth rods may be substituted by smooth square, half-round, rectangular splines or other shapes incorporating a smooth vertical-bearing surfaces.

4. A bridge for stringed violin family musical instruments according to claim 3 wherein:
said individual bridge pieces may employ said splines, threaded rods, and adjustment wheels in either single or multiple arrangements.

5. A bridge for stringed violin family musical instruments according to claim 4 wherein:
The constituent parts of said bridge and/or bridge saddles may consist in entirety or in a combination of material including but not limited to: synthetic compounds, metal, wood, composite material, plastic, fiberglass, and glass.
